(19) United States
(12) Patent Application Publication
(10) Pub. No.: US 2006/0000700 A1
(43) Pub. Date: Jan. 5, 2006

(54) Switch contacts

(75) Inventor: David H. Kerr, Burscough (GB)

Correspondence Address: ROCKWELL AUTOMATION, INC./(QB), ATTENTION: SUSAN M. DONAHUE, 1201 SOUTH SECOND STREET, MILWAUKEE, WI, 53204, US

(73) Assignee: EJA Limited

(21) Appl. No.: 11/104,358

(22) Filed: Apr. 12, 2005

(30) Foreign Application Priority Data
Jun. 30, 2004 (GB) 0414587.6

(51) Int. Cl. H01H 5/00

(52) U.S. Cl. 200/400

(57) ABSTRACT

A switch contact block assembly has a plurality of stationary contact pairs, a contact carriage carrying movably therewith a plurality of bridge contacts, positioned to make or break contact with the stationary contact pairs, according to a position of the contact carriage, and wherein the contact carriage is guided for rectilinear sliding movement, and wherein the plurality of bridge contacts have a substantially fixed positional relationship with one another whereby a making and a breaking of the contacts occurs substantially simultaneously.

### TECHNICAL FIELD

The present invention relates to improvements in or relating to switch contacts.

### BACKGROUND ART

An existing electrical switch comprises a contact block having a series of bridge contacts positioned in a contact block plunger. The plunger has apertures cut through its centre to allow location of the bridge contacts and insulating barriers. The bridge contacts are spring loaded to ensure correct contact pressure against other contacts (referred to as fixed contacts) of the contact block assembly. A pair of the other fixed contacts are provided for each bridge contact with respective contacts of each pair disposed to one and the other side of the contact block plunger respectively.

Because of the confined space in most contact block designs, the allowable movement of the contact plunger is restricted, leading to a close spacing of the fixed contacts and bridge contacts.

The contact block is required to be available in several contact switching options, for example, four normally closed contacts, or two normally open, two normally closed. Engagement of a switch actuator changes the state of these contacts from open to closed, or vice versa. The close but relatively moveable relationship of the bridge contacts to each other can lead to incorrect timing of the contact switching.

The design also places a restriction on the number of contacts within any switch. Extra contacts are added sequentially along the centre axis of the plunger, increasing the length of the contact block. Overall switch dimensions conform to existing standards, either historically, or regulatory, and variance away from these significantly reduces their use.

The market is increasingly asking for “simultaneous” switch of controls, i.e., in a four normally closed contact block, all contacts must change state (break to the open position) within a maximum of 50 milliseconds. This can cause problems with separate spring loaded bridge contacts.

It is an aim of the present invention to address one or more of the above concerns and produce an improved switch contact block assembly.

### SUMMARY OF THE INVENTION

Accordingly a first aspect of the invention provides a switch contact block assembly comprising a plurality of fixed contact pairs, a contact carriage carrying movably therewith a plurality of bridge contacts, positioned to make or break contact with prescribed fixed contact pairs, according to the (translational) position of the contact carriage, and wherein the contact carriage is guided for rectilinear sliding movement, and wherein the plurality of bridge contacts have a substantially fixed positional relationship with one another whereby make and break of the contacts occurs substantially simultaneously.

Conveniently, the bridge contacts comprise at least two bridge contacts that are disposed in side by side relation substantially normal to the direction of sliding movement of the contact carriage (hereinafter referred to as first contact pairs). More conveniently, there are at least two further bridge contacts disposed in side by side relation substantially normal to the direction of sliding movement of the contact carriage and spaced apart from the first contact pairs in the direction of sliding movement of the contact carriage (and hereinafter referred to as second contact pairs). There may be further contact pairs that are similarly axially separated from the other contact pairs. The use of the term bridge contact pairs is not necessarily to be taken as meaning that there are only two bridge contacts. The respective bridge contact pairs may comprise more than two bridge contacts.

Conveniently the contact carriage comprises a central axially extending spine and at least one spur extending at right angles thereto and from opposite sides thereof to carry at least one of the aforesaid bridge contact to each side of the spine. The spurs that branch to opposite sides of the central spine are preferably in alignment with one another but that is not to exclude the possibility of them being in staggered relationship. Preferably there will be at least two sets of lateral spurs carrying bridge contacts.

Conveniently the central carriage is mounted for sliding movement about a guide rail. The central spine may comprise a hollow tubular element, preferably of non-circular cross-section, and the guide may have a complimentary cross-section to receive the contact carriage slidably and non-rotatably thereon.

For certain applications the carriage may be guided by a pair of side guides rather than the single central guide, in which case the bridge contacts are preferably carried on limbs of the contact carriage that extended between positions of engagement with the side guides.

In a preferred embodiment the bridge contact is moulded into a flexible, current resistive material, which serves to connect/locate the bridge contact with respect to the contact carriage. The current resistive material preferably comprises a rubber or plastics material or such other material. The bridge contact assembly may be symmetrical with a bridge contact moulded in, one either side.

According to a second aspect of the invention there is provided a switch contact block assembly comprising a contact carriage carrying movably therewith a plurality of bridge contacts and wherein the bridge contacts are coupled to the contact carriage by away of a contact carrier comprising a flexible, current resisting material.

More particularly, the bridge contact is moulded into said contact carrier. More particularly still the contact carrier may be a push fit in a reception location of the contact carriage. In an alternative the contact carrier is bonded to the contact carriage.

A preferred contact carriage comprises a spur or limb which is hollow and which is adapted to receive the contact carrier, and wherein the limb has an aperture through which the bridge contact of the contact carrier projects. More preferably still, the contact carrier has two bridge contacts moulded therein and spaced apart and disposed facing in opposite directions to project through respective apertures in the contact carriage.

According to a third aspect of the invention there is provided a method of assembling a contact block assembly comprising a contact carriage, at least one bridge contact and a bridge contact carrier, the method comprising moulding at least one bridge contact into a bridge contact carrier made of a flexible current resistant material, and inserting the carrier together with said bridge contact into a reception location of the contacts carriage to position the bridge contact ready for use. The bridge contact may be spaced from the contact carriage by the insertion of the contact carrier material therebetween.

More preferably, the contact carriage comprises at least one hollow limb, and preferably a plurality of hollow limbs, preferably extending from one and the other sides of a central spine, and wherein the hollow limbs have apertures therein through which the bridge contacts project in their position of use, and wherein, the method further comprises inserting the contact carrier assembly into the hollow limb through an opening therein, preferably in an end thereof, and the aperture is in a side wall of the limb spaced from openings therein in the direction of insertion of the carrier assembly.

Preferably the method comprises inserting a plurality of contact carriers into cooperating engagement with respective reception locations of the contact carriage so that bridge contacts thereof are aligned with reception locations therefor.

### BRIEF DESCRIPTION OF THE DRAWINGS

The present invention will now be described further hereinafter, by way of example only, with reference to the accompany drawings; in which:—

FIG. 1 is a perspective view of a contact carriage assembly according to the invention,

FIG. 2 is a perspective view of the contact carriage assembly of FIG. 1 from a different angle and shown mounted on a guide rail,

FIG. 3 is a perspective view of the contact carriage and guide of FIG. 2 and further illustrating a first positional relationship with fixed contacts, and

FIG. 4 is a view looking in the direction of arrow A of FIG. 3.

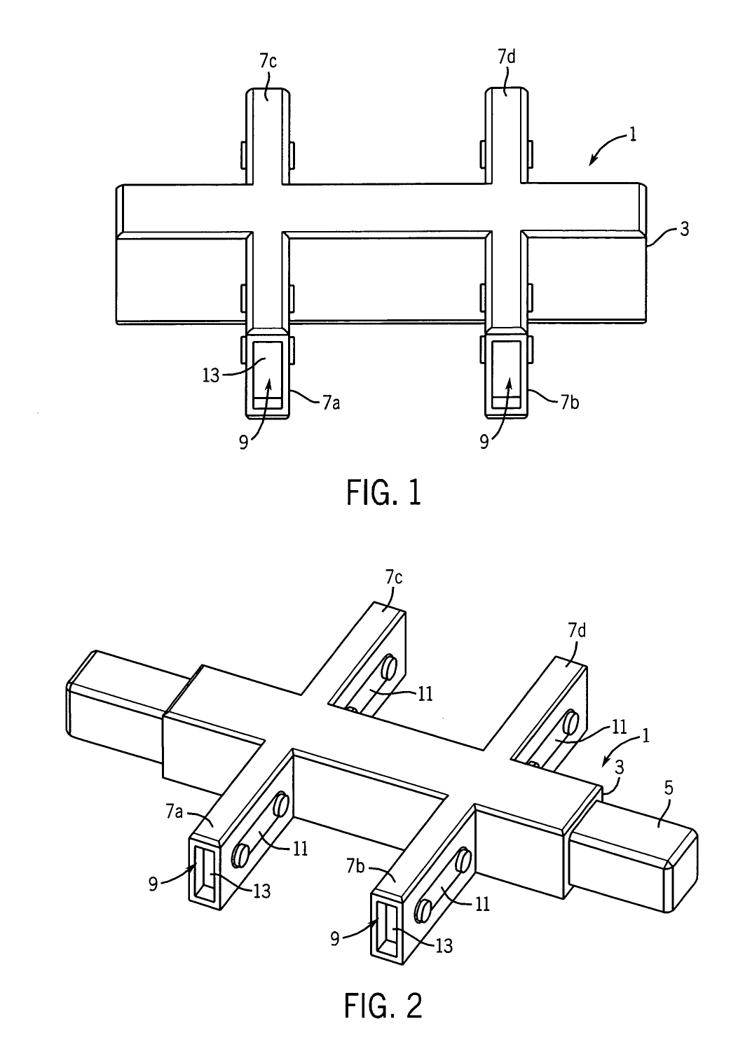

### DESCRIPTION OF THE PREFERRED EMBODIMENT

A contact block assembly according to the invention comprises a contact carriage 1 comprising a central hollow spine 3 of non-circular configuration, as viewed in cross-section, that is mounted for slideable movement on a guide rail 5. The guide rail is part of a switch housing (not illustrated).

The hollow spine 3 has limbs 7 that extend from the spine. In the illustrated embodiment there are four limbs with two limbs 7a, 7b extending from one and the same side of the central spine and two limbs 7c, 7d extending from the other side of the spine and in the illustrated embodiment limbs 7a and 7c, are aligned with one another, as are limbs 7b and 7d. The respective aligned pairs of limbs 7a, 7c and 7b, 7d are spaced apart in the longitudinal direction of the spine.

The limbs 7a-7d are hollow and have end openings 9. In addition they have apertures through which bridge contacts II project. The bridge contacts II are moulded into a contact carrier 13 that is made of a flexible, current resistant material, which is rubber or plastics or such like. The bridge contact II projects from the moulded body of the contact carrier. The contact carrier 13 is sufficiently flexible/compressible to enable it to be inserted into the open end of the limb 7 despite the fact that the bridge contact projects therefrom. The contact carrier is inserted until the bridge contact enters the aperture therefor in the side walling of the limb 7. The contact carriage is preferably made from a non-conducting plastics material.

In the illustrated embodiment, each contact carrier 13 has two sets of bridge contacts moulded therein and they project from opposite sides of the contact carrier, so that the bridge contacts project from apertures is opposite sides of the limb 7.

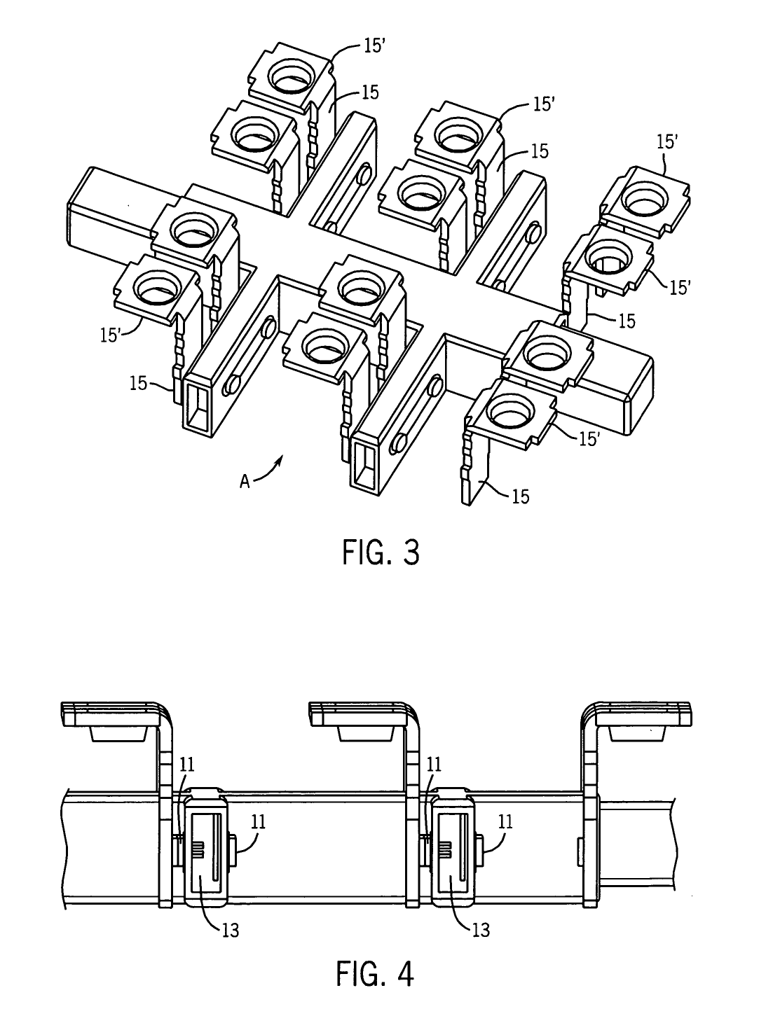

FIGS. 3 and 4 illustrate the location of fixed contacts 15. These are disposed in pairs, one pair for each bridge contact II. Six pairs of fixed contacts are shown by way of example in the illustrated embodiment. The fixed contacts are mounted with respect to a switch housing (not illustrated) and the pairs 15 are apertured to receive a screw of a cable clamp. The contact carriage is shown in a first end portion in which four of the pairs of fixed contacts are made by contact with the bridge contact II.

By virtue of the described construction, all the bridge contacts have a fixed relationship and thus making and breaking of the contacts occurs substantially simultaneously. The switch operation can be designed to give a “slow make/break” or a “snap action” movement during normal use by appropriate loading of the contact carriage. The use of a contact carrier of flexible non-conductive material provides an advantageous assembly method. A large number of contact combinations can be accommodated with in a design that has a compact overall length.

The contact block assembly of the present invention finds application in our range of safety switches and the methods employed for actuating these switches may be employed with the aforedescribed contact block assembly.

Manufacture of the contact block assembly calls for moulding of a contact carriage with the aforesaid hollow limbs 7 and reception locations for bridge contacts therein, and moulding of bridge contacts into the flexible, non-conductive carrier therefor. The bridge contacts are then positioned in the apertures therefor by inserting the carrier into the open end of the limb 7 until the bridge contact engages with the apertures therefor. Thus this entails initial compression of the contact and subsequent expansion whereby the bridge contacts carrier are held in the desired position.

1. A switch contact block assembly comprising a plurality of stationary contact pairs, a contact carriage carrying movably therewith a plurality of bridge contacts, positioned to make or break contact with prescribed stationary contact pairs, according to a position of the contact carriage, and wherein the contact carriage is guided for rectilinear sliding movement, and wherein the plurality of bridge contacts have a substantially fixed positional relationship with one another whereby a making and a breaking of the contacts occurs substantially simultaneously.

2. A switch contact block assembly as claimed in claim 1 in which the bridge contacts comprise at least two bridge contacts that are disposed in side-by-side relationship substantially normal to the direction of sliding movement of the contact carriage.

3. A switch contact block assembly as claimed in claim 2 in which there are at least two further bridge contacts disposed in side-by-side relationship substantially normal to the direction of sliding movement of the contact carriage and spaced apart from the first contact pairs in the direction of sliding movement of the contact carriage.

4. A switch contact block assembly as claimed in claim 1 in which the contact carriage comprises a central axially extending spine and at least one spur extending at right angles thereto and from opposite sides thereof to carry at least one of the aforesaid bridge contact to each side of the spine.

5. A switch contact block assembly as claimed in claim 4 in which the spurs that branch to opposite sides of the central spine are in alignment with one another.

6. A switch contact block assembly as claimed in claim 4 in which the spurs are disposed in a staggered relationship.

7. A switch contact block assembly as claimed in claim 4 in which there are at least two sets of lateral spurs carrying bridge contacts.

8. A switch contact block assembly as claimed in claim 4 in which the central carriage is mounted for sliding movement about a guide rail.

9. A switch contact block assembly as claimed in claim 4 in which the central spine comprises a hollow tubular element, of non-circular cross-section, and the guide has a complimentary cross-section to receive the contact carriage slidably and non-rotatably thereon.

10. A switch contact block assembly as claimed in claim 1 in which the carriage is guided by a pair of side guides and the bridge contacts are carried on limbs of the contact carriage that extended between the positions of engagement with the side guides.

11. A switch contact block assembly as claimed in claim 1 in which the bridge contact is moulded into a flexible, current resistive material, which serves to connect and/or locate the bridge contact with respect to the contact carriage.

12. A switch contact block assembly as claimed in claim 11 in which the current resistive material comprises a rubber or plastics material.

13. A switch contact block assembly as claimed in claim 11 in which the bridge contact assembly is symmetrical with a bridge contact moulded in, one either side.

14. A switch contact block assembly comprising a contact carriage carrying movably therewith a plurality of bridge contacts and wherein the bridge contacts are coupled to the contact carriage by away of a contact carrier comprising a flexible, current resisting material.

15. A switch contact block assembly as claimed in claim 14 in which the bridge contact is moulded into said contact carrier.

16. A switch contact block assembly as claimed in claim 14 in which the contact carrier is a push fit in a reception location of the contact carriage.

17. A switch contact block assembly as claimed in claim 14 in which the contact carrier is bonded to the contact carriage.

18. A switch contact block assembly as claimed in claims 14 in which the contact carriage comprises a spur or limb which is hollow and which is adapted to receive the contact carrier, and wherein the limb has an aperture through which the bridge contact of the contact carrier projects.

19. A switch contact block assembly as claimed in claim 14 in which the contact carrier has two bridge contacts moulded therein and spaced apart and disposed facing in opposite directions to project through respective apertures in the contact carriage.

20. A method of assembling a contact block assembly comprising a contact carriage, at least one bridge contact and a bridge contact carrier, the method comprising moulding at least one bridge contact into a bridge contact carrier made of a flexible current resistant material, and inserting the carrier together with said bridge contact into a reception location of the contacts carriage to position the bridge contact ready for use.

21. A method of assembling a contact block assembly of a type in which the contact carriage comprises at least one hollow limb, and wherein the hollow limb has an aperture therein through which the bridge contacts project in their position of use, and wherein, the method further comprises inserting the contact carrier assembly into the hollow limb through an opening therein, to a position to project through said aperture in a side wall of the limb spaced from opening therein.

22. A method as claimed in claim 21 in which the method comprises inserting a plurality of contact carriers into cooperating engagement with respective reception locations of the contact carriage so that bridge contacts thereof are aligned with reception locations therefor.
